(19) United States
(12) Patent Application Publication
(10) Pub. No.: US 2007/0112139 A1
(43) Pub. Date: May 17, 2007

(54) Peroxide-cured thermoplastic vulcanizates and process for making the same

(76) Inventors: Maria D. Ellul, Silver Lake Village, OH (US); Palanisamy Arjunan, Houston, TX (US)

Correspondence Address: William G. Muller;Patent Counsel, Advanced Elastomer Systems, 388 So. Main Street, Akron, OH, 44311-1059, US

(21) Appl. No.: 11/273,337

(22) Filed: Nov. 14, 2005

(51) Int. Cl. C08F 8/00

(52) U.S. Cl. 525/192

(57) ABSTRACT

A composition comprising a dynamically-cured rubber and thermoplastic resin, where the rubber includes one or more mer units of divinyl benzene, and where the rubber is dynamically cured with a free-radical curative. In one or more embodiments, the rubber is highly cured, and therefore the composition may exhibit technologically useful engineering properties. Also, this cure can be achieved in one or more embodiments with reduced curative and/or reduced diene content.

### FIELD OF THE INVENTION

One or more embodiments of the present invention relate to thermoplastic vulcanizates prepared by dynamically curing olefinic elastomeric copolymers including one or more mer units deriving from divinyl benzene.

### BACKGROUND OF THE INVENTION

Thermoplastic elastomers are known. They have many of the properties of thermoset elastomers, yet they are processable as thermoplastics. One type of thermoplastic elastomer is a thermoplastic vulcanizate, which may be characterized by finely-divided rubber particles dispersed within a plastic matrix. These rubber particles are crosslinked to promote elasticity.

In many instances, elastomeric olefinic copolymers (e.g., ethylene-propylene-diene terpolymers) are employed as the rubber component of thermoplastic vulcanizates. For example, U.S. Pat. No. 6,939,918 discloses the manufacture of thermoplastic vulcanizates by employing terpolymers of ethylene, propylene, and diene monomer such as 5-ethylidene-2-norbornene; 1,4-hexadiene; 5-methylene-2-norbornene; 1,6-octadiene; 5-methyl-1,4hexadiene; 3,7-dimethyl-1,6-octadiene; 1,3-cyclopentadiene; 1,4cyclohexadiene; dicyclopentadiene; 5-vinyl-2-norbornene, and divinyl benzene. This rubber can be dynamically cured by using any curative capable of crosslinking the elastomeric copolymer including phenolic resins, peroxides, maleimides, and silicon-based curatives.

Thermoplastic vulcanizates that are dynamically vulcanized with peroxide cure systems advantageously are non-hygroscopic, halide-free, lighter in color, thermally stable, and contain less residues. One shortcoming associated with the use of a peroxide cure system is the deleterious impact on the thermoplastic polymers within the thermoplastic vulcanizates. Namely, the peroxide curatives are believed to degrade the thermoplastics (e.g., polypropylene) via chain scission. As a result, thermoplastic vulcanizates that are fully cured by peroxide cure systems may typically be characterized by lower ultimate tensile strength, lower elongation at break, and lower melt strength.

The prior art has attempted to overcome these shortcomings. For example, U.S. Pat. No. 4,985,502 teaches the use of less peroxide curative. Unfortunately, however, the use of a limited amount of peroxide precludes the ability to fully cure the rubber and engineering properties are sacrificed.

Also, U.S. Pat. No. 5,656,693 attempts to alleviate the problem of polypropylene degradation, and yet achieve a full cure of the rubber, by employing a rubber terpolymer that includes vinyl norbornene as a polymeric unit. These rubbers are more efficiently curable with peroxides and therefore the amount of peroxide required to achieve a full cure is reduced, which thereby reduces the impact on the polypropylene.

Inasmuch as the use of peroxide cure systems to dynamically cure—and ideally fully cure—the rubber phase of thermoplastic vulcanizates may offer many advantages, there remains a desire to improve upon the ability to employ a peroxide cure system in the manufacture of thermoplastic vulcanizates.

### SUMMARY OF THE INVENTION

The present invention provides a composition comprising a dynamically-cured rubber and thermoplastic resin, where the rubber includes one or more mer units of divinyl benzene, and where the rubber is dynamically cured with a free-radical curative. In one or more embodiments, the rubber is highly cured, and therefore the composition may exhibit technologically useful engineering properties. Also, this cure can be achieved in one or more embodiments with reduced curative and/or reduced diene content.

### DETAILED DESCRIPTION OF ILLUSTRATIVE EMBODIMENTS

Thermoplastic vulcanizates of the present invention include dynamically cured olefinic elastomeric copolymers, where the olefinic elastomeric copolymer includes one or more mer units deriving from divinyl benzene, and the copolymers are cured by employing a free-radical cure system. It has been surprisingly discovered that the use of olefinic elastomeric copolymer including one or more mer units deriving from divinyl benzene allows for the production of highly cured thermoplastic vulcanizates characterized by technologically useful properties.

The thermoplastic vulcanizates of one or more embodiments of this invention include a dynamically-cured rubber and a thermoplastic resin. Other optional ingredients or constituents may include processing additives, oils, fillers, and other ingredients that are conventionally included in thermoplastic vulcanizates.

Olefinic elastomeric copolymers including one or more units deriving from divinyl benzene (Le., including one or more divinyl benzene mer units) include copolymers of ethylene, at least one α-olefin monomer, divinyl benzene, and optionally at least one other diene monomer. The α-olefins may include, but are not limited to, propylene, 1-butene, 1-hexene, 4-methyl-1 pentene, 1-octene, 1-decene, or combinations thereof. In one or more embodiments, these olefinic elastomeric copolymers may be referred to as DVB-elastomeric copolymers, DVB-rubber, or ethylene-α-olefin-divinyl benzene polymers or terpolymers.

The DVB-elastomeric copolymers may include from about 12 to about 85% by weight, in other embodiments from about 20 to about 80% by weight, in other embodiments from about 40 to about 70% by weight, and in other embodiments from about 60 to about 66% by weight ethylene units mer units (i.e., those units deriving from the polymerization of ethylene), and from about 0.1 to about 15% by weight, in other embodiments from about 0.15 to about 10% by weight, in other embodiments from about 0.2 to about 5% by weight, and in other embodiments from about 0.25 to about 3% by weight mer units deriving from divinyl benzene, with the balance including α-olefin mer units (such as propylene), which derive from α-olefin monomer. Expressed in mole percent, the terpolymer of one embodiment includes from about 0.1 to about 3 mole percent, in other embodiments from about 0.15 to about 2 mole percent, and in other embodiments from about 0.2 to about 0.5 mole percent mer units deriving from divinyl benzene.

Where the olefinic elastomeric copolymers include one or more mer units deriving from an additional diene, the additional dienes may be selected from 5-ethylidene-2-norbornene; 1,4hexadiene; 5-methylene-2-norbornene; 1,6-octadiene; 5-methyl-1,4-hexadiene; 3,7-dimethyl-1,6-octadiene; 1,3-cyclopentadiene; 1,4cyclohexadiene; dicyclopentadiene; 5-vinyl-2-norbornene, or combinations thereof. In one embodiment, the olefinic elastomeric copolymer is a tetrapolymer of ethylene, at least one α-olefin, divinyl benzene, and 5-vinyl-2-norbornene. In this embodiment, the tetrapolymer may include from about 0.05 to about 7.5, in other embodiments from about 0.08 to about 5, and in other embodiments from about 0.1 to about 2.5% by weight mer units deriving from divinyl benzene, and from about 0.05 to about 7.5, in other embodiments from about 0.08 to about 5, and in other embodiments from about 0.1 to about 2.5% by weight mer units deriving from 5-ethylidene-2-norbornene.

The DVB-elastomeric copolymers can have a weight average molecular weight (M_{w}) that is from about 25 to about 1,200,000 kg/mole, in other embodiments form about 100 to about 500 kg/mole, and in other embodiments from about 200 to about 400 kg/mole. The DVB-elastomeric copolymers can have a number average molecular weight (Mₙ) that is from about 15 to about 600 kg/mole, in other embodiments form about 50 to about 250 kg/mole, and in other embodiments from about 100 to about 200 kg/mole. The DVB-elastomeric copolymers can have a Z-average molecular weight (M_{z}) that is from about 35 to about 1,400,000 kg/mole, in other embodiments form about 150 to about 800 kg/mole, and in other embodiments from about 300 to about 600 kg/mole. The DVB-elastomeric copolymers may also be characterized by a molecular weight distribution (M_{w}/Mₙ) of less than 10, in other embodiments less than 6, and in other embodiments less than 3. Molecular weight may be determined by gel permeation chromatography (GPC), such as with a Waters 150 C high temperature instrument, using polystyrene standards.

The DVB-elastomeric copolymers may be characterized by having an intrinsic viscosity, as measured in Decalin at 135° C., up from about 1 to about 8 dl/g, in other embodiments from about 2 to about 7 dl/g, and in other embodiments from about 2.5 to about 5 dl/g.

The DVB-elastomeric copolymers may also be characterized by having a Mooney viscosity (ML₍₁₊₄₎ at 125° C.), per ASTM D 1646, of from about 20 to about 350 or from about 30 to about 300. In one or more embodiments, the DVB-elastomeric copolymer may be oil-extended. These oil-extended copolymers may include from about 10 to about 100 parts by weight or from about 20 to about 80 parts by weight oil per 100 parts by weight rubber of a paraffinic oil. The Mooney viscosity of these oil-extended copolymers may be from about 20 to about 100 or from about 30 to about 80.

The DVB-elastomeric copolymers may be branched. In one or more embodiments, the DVB-elastomeric copolymers may be characterized by a viscosity average branching index of less than about 1, in other embodiments less than 0.8, in other embodiments less than 0.6, and in other embodiments less than 0.4.

The branching index, g′, at a given molecular weight may be determined according to the formula g′=[η]_{ibranched}/[η]ᵢₗᵢₙₑₐᵣ, where [η]_{branched} is the viscosity of the branched polymer at the given molecular weight slice, i, and [η]ₗᵢₙₑₐᵣ is the viscosity of the known linear reference polymer at the given molecular weight slice. And, the average branching index ,<g′>, of the entire polymer can be determined according to the formula <g′>=[η]_{branched}/[η]linear, where [η]_{branched} is the viscosity of the branched polymer, and [n]ₗᵢₙₑₐᵣ is the viscosity of a known linear reference polymer, where the branched and linear polymers have the same molecular weight.

The viscosity average branching index (<g′>ᵥᵢₛ) of the entire polymer may be obtained from the following equation:

$$< {g}^{′} {>}_{vis} = \frac{{\sum }_{i = 1}^{N} {{C}_{i} [ η ]}_{i}}{{\sum }_{i = 1}^{N} {C}_{i} [ K {M}_{i}^{α} ]}$$

where Mi is the molecular weight of the polymer, [η]ᵢ is the intrinsic viscosity of the branched polymer at molecular weight Mi, Cᵢ is the concentration of the polymer at molecular weight Mi, and K and α are measured constants from a linear polymer as described by Paul J. Flory at page 310 of PRINCIPLES OF POLYMER CHEMISTRY (1953), and the summation is over all the slices in the distribution. The <g′>ᵥᵢₛ values are obtained by gel permeation chromatography (GPC) while the polymer is in dilute solution within 1,2,4 trichlorobenzene. The GPC is equipped with triple detectors; differential refractive index (DRI), light scattering and viscosity. The DRI is calibrated with both polystyrene and low molecular weight polyethylene standards, the light scattering detector with a series of polymers of known molecular weight, and the differential viscometer with a series of polymers of known intrinsic viscosities.

The DVB-elastomeric copolymers employed in preparing the thermoplastic vulcanizates of the present invention may be characterized by a low gel content. In one or more embodiments, the gel content may be less than 10% by weight, in other embodiments less than 8% by weight, in other embodiments less than 5% by weight, and in other embodiments less than 3% by weight. The gel content may be determined according to the mass loss observed during standard GPC analysis. In other embodiments, gel can be determined by determining the amount of rubber that is extractable from the thermoplastic vulcanizate by using cyclohexane or boiling xylene as an extractant. In certain embodiments, the DVB-elastomeric copolymers are substantially devoid of gel, which refers to that amount of gel or less that will not have an appreciable impact on the thermoplastic vulcanizates.

In one or more embodiments, the DVB-elastomeric copolymers may be prepared by polymerizing ethylene, an α-olefin (e.g., propylene), and divinyl benzene in the presence of at least one bridged metallocene catalyst. In one or more embodiments, these bridged metallocene catalysts include idenyl metallocenes (e.g., bis cyclopentadienyl metallocenes) and derivatives thereof. These catalysts may be used in conjunction with cocatalysts including methyl aluminoxanes (MAO), or ionic activators. In one embodiment, the metallocene catalyst includes halfnium, and the catalyst is MAO free.

In one embodiment, the metallocene catalysts may include an alkyl bridged metallocene compound that has at least two indenyl rings or derivatives of indenyl rings, which may be substituted at, for example, the 4 and/or 7 positions.

In another embodiment, the metallocene catalyst may include an alkyl bridged metallocene compound that has at least two indenyl rings or substituted indenyl rings, which may be substituted, for example, at the 2 position, or at the 2 and 4 positions. In one embodiment, the 4-position substitution includes an aryl substituent.

In yet another embodiment, the metallocene catalyst may include a substituted or unsubstituted silyl-bridged or ethylene-bridged bis-indenyl metallocene.

One or more metallocenes may be represented by the formula CPₘ MRₙ X_{q}, where Cp is a cyclopentadienyl ring or derivative thereof, M is a group 4, 5, or 6 transition metal, R is a hydrocarbyl group or hydrocarboxy group having from 1 to 20 carbon atoms, X is a halogen or an alkyl group, and m is an integer from about 1 to about 3, n is an integer from 0 to 3, q is an integer from 0 to 3, and the sum of m, n, and q is equal to the oxidation state of the transition metal. Examples of metallocenes are discussed in U.S. Pat. Nos. 4,530,914; 4,542,199; 4,769,910; 4,808,561; 4,871,705; 4,892,851; 4,933,403; 4,937,299; 5,017,714; 5,057,475; 5,120,867; 5,132,381; 5,155,080; 5,198,401; 5,278,199; 5,304,614; 5,324,800; 5,350,723; 5,391,790; 5,580,939; 5,324,800; 5,599,761; 5,276,208; 5,239,022; 5,243,001; 5,057,475; 5,017,714; 5,120,867; 5,714,556; 6,376,410; 6,376,412; 6,380,120; 6,376,409; 6,380,122; and 6,376,413, which are incorporated herein by reference.

Other techniques for polymerizing DVB-elastomeric copolymers may also be employed. For example, other techniques are disclosed in U.S. Pat. Nos. 6,414,102 and 6,096,849, which are incorporated herein by reference.

In one or more embodiments, the DVB-rubber within the thermoplastic vulcanizate can be partially or highly cured. In one embodiment, the rubber is advantageously completely or fully cured. The degree of cure can be measured by determining the amount of rubber that is extractable from the thermoplastic vulcanizate by using cyclohexane or boiling xylene as an extractant. This method is disclosed in U.S. Pat. No. 4,311,628, which is incorporated herein by reference for purpose of U.S. patent practice. In one embodiment, the rubber has a degree of cure where not more than 10 weight percent, in other embodiments not more than 6 weight percent, in other embodiments not more than 5 weight percent, and in other embodiments not more than 3 weight percent is extractable by cyclohexane at 23° C. as described in U.S. Pat. Nos. 5,100,947 and 5,157,081, which are incorporated herein by reference for purpose of U.S. patent practice. Alternatively, in one or more embodiments, the rubber has a degree of cure such that the crosslink density is preferably at least 4×10⁻⁵, in other embodiments at least 7×10⁻⁵, and in other embodiments at least 10×10⁻⁵ moles per milliliter of rubber. See also “Crosslink Densities and Phase Morphologies in Dynamically Vulcanized TPEs,” by Ellul et al., RUBBER CHEMISTRY AND TECHNOLOGY, Vol. 68, pp. 573-584 (1995).

In one or more embodiments, the thermoplastic vulcanizates of the present invention may also include other rubber components in addition to the elastomeric copolymers including divinyl benzene mer units. These other rubbers include those conventionally employed in the manufacture of thermoplastic vulcanizates. In one embodiment, the additional rubber includes a high molecular weight olefinic copolymer of ethylene, α-olefin, and diene. In general, high molecular weight olefinic copolymers include those characterized by an intrinsic viscosity, in Decalin at 135° C., of at least 2.3, a number average molecular weight of at least 80 kg/mole, and/or a weight average molecular weight of at least 250 kg/mole. Exemplary conventional rubbers are disclosed in U.S. Pat. Nos. 5,656,693, 6,153,704, 4,311,628, and 4,889,888, which are incorporated herein by reference.

Any thermoplastic resin that can be employed in the manufacture of thermoplastic vulcanizates can be used to manufacture the thermoplastic vulcanizates of this invention. Useful thermoplastic resins include solid, generally high molecular weight plastic resins. These resins include crystalline and semi-crystalline polymers including those having a crystallinity of at least 25% as measured by differential scanning calorimetry. Selection of particular resins may include those that have a melt temperature lower than the decomposition temperature of the rubber selected.

In one or more embodiments, useful thermoplastic resins may be characterized by an M_{w} of from about 200,000 to about 2,000,000 and in other embodiments from about 300,000 to about 600,000. They are also characterized by an Mₙ of about 80,000 to about 800,000, and in other embodiments about 90,000 to about 150,000, as measured by GPC with polystyrene standards.

In one or more embodiments, these thermoplastic resins can have a melt flow rate that is less than about 10 dg/min, in other embodiments less than about 2 dg/min, in other embodiments less than about 1.0 dg/min, and in other embodiments less than about 0.5 dg/min, per ASTM D-1238 at 230° C. and 2.16 kg load.

In one ore more embodiments, these thermoplastic resins also can have a melt temperature (Tₘ) that is from about 150° C. to about 250° C., in other embodiments from about 155 to about 170° C., and in other embodiments from about 160° C. to about 165° C. They may have a glass transition temperature (T_{g}) of from about −10 to about 10° C., in other embodiments from about −3 to about 5° C., and in other embodiments from about 0 to about 2° C. In one or more embodiments, they may have a crystallization temperature (T_{c}) of these optionally at least about 75° C., in other embodiments at least about 95° C., in other embodiments at least about 100° C., and in other embodiments at least 105° C., with one embodiment ranging from 105° to 115° C.

Also, these thermoplastic resins may be characterized by having a heat of fusion of at least 25 J/g, in other embodiments in excess of 50 J/g, in other embodiments in excess of 75 J/g, in other embodiments in excess of 95 J/g, and in other embodiments in excess of 100 J/g.

Exemplary thermoplastic resins include crystalline and crystallizable polyolefins. Also, the thermoplastic resins may include copolymers of polyolefins with styrene such as styrene-ethylene copolymer. In one embodiment, the thermoplastic resins are formed by polymerizing ethylene or α-olefins such as propylene, 1-butene, 1-hexene, 1-octene, 2-methyl-1-propene, 3-methyl-1-pentene, 4-methyl-1-pentene, 5-methyl-1-hexene, and mixtures thereof. Copolymers of ethylene and propylene and ethylene and/or propylene with another α-olefin such as 1-butene, 1-hexene, 1-octene, 2-methyl-1-propene, 3-methyl-1-pentene, 4-methyl-1-pentene, 5-methyl-1-hexene or mixtures thereof is also contemplated. Specifically included are the reactor, impact, and random copolymers of propylene with ethylene or the higher α-olefins, described above, or with C₁₀-C₂₀ diolefins. Comonomer contents for these propylene copolymers will typically be from 1 to about 30% by weight of the polymer, for example, See U.S. Pat. Nos. 6,268,438, 6,288,171, 6,867,260 B2, 6,245,856, and U.S. Publication No. 2005/010753, which are incorporated herein by reference. Copolymers available under the tradename VISTAMAXX™ (ExxonMobil) are specifically included. Blends or mixtures of two or more polyolefin thermoplastics such as described herein, or with other polymeric modifiers, are also suitable in accordance with this invention. These homopolymers and copolymers may be synthesized by using an appropriate polymerization technique known in the art such as, but not limited to, the conventional Ziegler-Natta type polymerizations, and catalysis employing single-site organometallic catalysts including, but not limited to, metallocene catalysts.

In one embodiment, the thermoplastic resin includes a high-crystallinity isotactic or syndiotactic polypropylene. This polypropylene can have a density of from about 0.85 to about 0.91 g/cc, with the largely isotactic polypropylene having a density of from about 0.90 to about 0.91 g/cc. Also, high and ultra-high molecular weight polypropylene that has a fractional melt flow rate can be employed. These polypropylene resins are characterized by a melt flow rate that is less than or equal to 10 dg/min, optionally less than or equal to 1.0 dg/min, and optionally less than or equal to 0.5 dg/min per ASTM D-1238 at 2.16 kg load.

In one embodiment, the thermoplastic resin includes a propylene copolymer deriving from the copolymerization of monomer including i) propylene, ii) an α, internal non-conjugated diene monomer, iii) optionally an α, ω non-conjugated diene monomer, and iv) optionally ethylene, or a propylene copolymer deriving from the copolymerization of monomer including i) propylene, ii) an olefin containing a labile hydrogen, and iii) optionally ethylene. These propylene copolymers are disclosed in U.S. Ser. No. 10/938,369, which is incorporated herein by reference. These propylene copolymers can be used as the sole thermoplastic component, or they may be used in conjunction with other thermoplastic resins including those described herein.

In certain embodiments, the thermoplastic vulcanizate may include a polymeric processing additive. The processing additive may be a polymeric resin that has a very high melt flow index. These polymeric resins include both linear and branched polymers that have a melt flow rate that is greater than about 500 dg/min, more preferably greater than about 750 dg/min, even more preferably greater than about 1000 dg/min, still more preferably greater than about 1200 dg/min, and still more preferably greater than about 1500 dg/min. Mixtures of various branched or various linear polymeric processing additives, as well as mixtures of both linear and branched polymeric processing additives, can be employed. Reference to polymeric processing additives can include both linear and branched additives unless otherwise specified. Linear polymeric processing additives include polypropylene homopolymers, and branched polymeric processing additives include diene-modified polypropylene polymers. Thermoplastic vulcanizates that include similar processing additives are disclosed in U.S. Pat. No. 6,451,915, which is incorporated herein by reference for purpose of U.S. patent practice.

In one or more embodiments, the thermoplastic vulcanizates may include a mineral oil, a synthetic oil, or a combination thereof. These oils may also be referred to as plasticizers or extenders. Mineral oils may include aromatic, naphthenic, paraffinic, and isoparaffinic oils. In one or more embodiments, the mineral oils may be treated or untreated. Useful mineral oils can be obtained under the tradename SUNPAR™ (Sun Chemicals). Others are available under the name PARALUX™ (Chevron).

In one or more embodiments, synthetic oils include polymers and oligomers of butenes including isobutene, 1-butene, 2-butene, butadiene, and mixtures thereof. In one or more embodiments, these oligomers include isobutenyl mer units. Exemplary synthetic oils include polyisobutylene, poly(isobutylene-co-butene), polybutadiene, poly(butadiene-co-butene), and mixtures thereof. In one or more embodiments, synthetic oils may include polylinear α-olefins, polybranched α-olefins, hydrogenated polyalphaolefins, and mixtures thereof.

In one or more embodiments, the synthetic oils include synthetic polymers or copolymers having a viscosity in excess of about 20 cp, in other embodiments in excess of about 100 cp, and in other embodiments in excess of about 190 cp, where the viscosity is measured by a Brookfield viscometer according to ASTM D-4402 at 38° C.; in these or other embodiments, the viscosity of these oils can be less than 4,000 cp and in other embodiments less than 1,000 cp.

In one or more embodiments, these oligomers can be characterized by a number average molecular weight (Mₙ) of from about 300 to about 9,000 g/mole, and in other embodiments from about 700 to about 1,300 g/mole.

Useful synthetic oils can be commercially obtained under the tradenames Polybutene™ (Soltex; Houston, Tex.), Indopol™ (BP; Great Britain), and Parapol™ (ExxonMobil). Oligomeric copolymers deriving from butadiene and its comonomers are commercially available under the tradename Ricon Resin™ (Ricon Resins, Inc; Grand Junction, Colo.). White synthetic oil is available under the tradename SPECTRASYN™ (ExxonMobil), formerly SHF Fluids (Mobil).

In one or more embodiments, the extender oils may include organic esters, alkyl ethers, or combinations thereof including those disclosed in U.S. Pat. Nos. 5,290,866 and 5,397,832, which are incorporated herein by reference. In one or more embodiments, the organic esters and alkyl ether esters may have a molecular weight that is generally less than about 10,000. In one or more embodiments, suitable esters include monomeric and oligomeric materials having an average molecular weight of below about 2,000 and in other embodiments below about 600. In one or more embodiments, the esters may be compatible or miscible with both the polyalphaolefin and rubber components of the composition; i.e., they may mix with other components to forma single phase. In one or more embodiments, the esters include aliphatic mono- or diesters, or alternatively oligomeric aliphatic esters or alkyl ether esters. In one or more embodiments, the thermoplastic vulcanizates are devoid of polymeric aliphatic esters and aromatic esters, as well as phosphate esters.

In addition to the rubber, thermoplastic resins, and optional processing additives, the thermoplastic vulcanizates of the invention may optionally include reinforcing and non-reinforcing fillers, antioxidants, stabilizers, rubber processing oil, lubricants, antiblocking agents, anti-static agents, waxes, foaming agents, pigments, flame retardants and other processing aids known in the rubber compounding art. These additives can comprise up to about 50 weight percent of the total composition. Fillers and extenders that can be utilized include conventional inorganics such as calcium carbonate, clays, silica, talc, titanium dioxide, carbon black and the like.

In one or more embodiments, the thermoplastic vulcanizates of this invention contain a sufficient amount of the rubber to form rubbery compositions of matter. The skilled artisan will understand that rubbery compositions of matter include those that have ultimate elongations greater than 100 percent, and that quickly retract to 150 percent or less of their original length within about 10 minutes after being stretched to 200 percent of their original length and held at 200 percent of their original length for about 10 minutes.

Thus, in one or more embodiments, the thermoplastic vulcanizates can include at least about 25 percent by weight, in other embodiments at least about 45 percent by weight, in other embodiments at least about 65 percent by weight, and in other embodiments at least about 75 percent by weight rubber. In these or other embodiments, the amount of rubber within the thermoplastic vulcanizates can be from about 15 to about 90 percent by weight, in other embodiments from about 45 to about 85 percent by weight, and in other embodiments from about 60 to about 80 percent by weight, based on the entire weight of the rubber and thermoplastic combined. Where the thermoplastic vulcanizates include other rubbers in addition to the DVB rubber, the rubber may include at least 50% DVB rubber, in other embodiments at least 75% by weight DVB rubber, and in other embodiments at least 95% by weight DVB rubber.

In one or more embodiments, the amount of thermoplastic resin within the thermoplastic vulcanizates can be from about 15 to about 85% by weight, in other embodiments from about 20 to about 75% by weight, based on the entire weight of the rubber and thermoplastic combined. In these or other embodiments, the thermoplastic vulcanizates can include from about 15 to about 25, and in other embodiments from about 30 to about 60, and in other embodiments from about 75 to about 300 parts by weight thermoplastic resin per 100 parts by weight rubber.

When employed, the thermoplastic vulcanizates may include from about 0 to about 20 parts by weight, or from about 1 to about 10 parts by weight, or from about 2 to about 6 parts by weight of a polymeric processing additive per 100 parts by weight rubber.

Fillers, such as carbon black or clay, may be added in amount from about 10 to about 250, per 100 parts by weight of rubber. The amount of carbon black that can be used depends, at least in part, upon the type of carbon black and the amount of extender oil that is used.

Generally, from about 5 to about 300 parts by weight, or from about 30 to about 250 parts by weight, or from about 70 to about 200 parts by weight, of extender oil per 100 parts rubber can be added. The quantity of extender oil added depends upon the properties desired, with the upper limit depending upon the compatibility of the particular oil and blend ingredients; this limit is exceeded when excessive exuding of extender oil occurs. The amount of extender oil depends, at least in part, upon the type of rubber. High viscosity rubbers are more highly oil extendable. Where ester plasticizers are employed, they are generally used in amounts less than about 250 parts, or less than about 175 parts, per 100 parts rubber.

The DVB-rubber is cured or crosslinked by dynamic vulcanization. Dynamic vulcanization includes a vulcanization or curing process for a rubber within a blend with a thermoplastic resin, where the rubber may be crosslinked or vulcanized under conditions of high shear at a temperature above the melting point of the thermoplastic. In one embodiment, the rubber can be simultaneously crosslinked and dispersed as fine particles within the thermoplastic matrix, although other morphologies may also exist.

In one or more embodiments, dynamic vulcanization can be effected by employing a continuous process. Continuous processes may include those processes where dynamic vulcanization of the rubber is continuously achieved, thermoplastic vulcanizate product is continuously removed or collected from the system, and/or one or more raw materials or ingredients are continuously fed to the system during the time that it may be desirable to produce or manufacture the product.

In one or more embodiments, continuous dynamic vulcanization can be effected within a continuous mixing reactor, which may also be referred to as a continuous mixer. Continuous mixing reactors may include those reactors that can be continuously fed ingredients and that can continuously have product removed therefrom. Examples of continuous mixing reactors include twin screw or multi-screw extruders (e.g., ring extruder). Methods for continuously preparing thermoplastic vulcanizates are described in U.S. Pat. Nos. 4,311,628, 4,594,390, and 5,656,693 which are incorporated herein by reference for purpose of U.S. patent practice, although methods employing low shear rates can also be used. The temperature of the blend as it passes through the various barrel sections or locations of a continuous reactor can be varied as is known in the art. In particular, the temperature within the cure zone may be controlled or manipulated according to the half-life of the curative employed. Multiple step continuous processes can also be employed whereby ingredients such as plastics, oils, and scavengers can be added after dynamic vulcanization has been achieved as disclosed in International Application No. PCT/US04/30517 (International Publication No. WO 2005/028555), which is incorporated herein by reference for purpose of U.S. patent practice.

The cure system employed in preparing the thermoplastic vulcanizates of this invention includes a free-radical cure agent and a coagent. Free-radical cure agents include peroxides such as organic peroxides. Examples of organic peroxides include, but are not limited to, di-tert-butyl peroxide, dicumyl peroxide, t-butylcumyl peroxide, α,α-bis(tert-butylperoxy) diisopropyl benzene, 2,5-dimethyl-2,5-di(t-butylperoxy)hexane (DBPH), 1,1-di(tert-butylperoxy)-3,3,5-trimethyl cyclohexane, n-butyl-4-4-bis(tert-butylperoxy) valerate, benzoyl peroxide, lauroyl peroxide, dilauroyl peroxide, 2,5-dimethyl-2,5-di(tert-butylperoxy) hexyne-3, and mixtures thereof. Also, diaryl peroxides, ketone peroxides, peroxydicarbonates, peroxyesters, dialkyl peroxides, hydroperoxides, peroxyketals and mixtures thereof may be used. Others include azo initiators including Luazo™ AP (ATO Chemical). Useful peroxides and their methods of use in dynamic vulcanization of thermoplastic vulcanizates are disclosed in U.S. Pat. No. 5,656,693, which is incorporated herein by reference for purpose of U.S. patent practice. In certain embodiments, cure systems such as those described in U.S. Pat. No. 6,747,099, U.S. Application Publication No. 20040195550, and WIPO Publication Nos. 2002/28946, 2002/077089, and 2005/092966, which are incorporated herein by reference, may also be employed.

In one or more embodiments, the free-radical cure agent may be employed in conjunction with one or more coagents. Coagents may include high-vinyl polydiene or polydiene copolymer, triallylcyanurate, triallyl isocyanurate, triallyl phosphate, sulfur, N,N′-m-phenylenedimaleimide, N,N′-p-phenylenedimaleimide, divinyl benzene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, multi-functional acrylates, multi-functional methacrylates, or oximers such as quinone dioxime. Combinations of these coagents may be employed. For example, combinations of high-vinyl polydienes and α-β-ethylenically unsaturated metal carboxylates are useful, as disclosed in U.S. Ser. No. 11/180,235, which is incorporated herein by reference. Coagents may also be employed as neat liquids or together with a carrier. For example, the multi-functional acrylates or multi-functional methacrylates together with a carrier are useful, as disclosed in U.S. Ser. No. 11/246,773, which is incorporated herein by reference. Also, the curative and/or coagent may be pre-mixed with the plastic prior to formulation of the thermoplastic vulcanizate, as described in U.S. Pat. No. 4,087,485, which is incorporated herein by reference.

The skilled artisan will be able to readily determine a sufficient or effective amount of curative and/or coagent to be employed without undue calculation or experimentation. In one or more embodiments, practice of the present invention may advantageously reduce the amount of curative required to achieve a desired level of cure (e.g., full cure). In one or more embodiments, the amount of curative employed may be less than 75%, in other embodiments less than 50%, in other embodiments less than 35%, and in other embodiments less than 25% of that amount of curative required to achieve a desired cure using conventional olefinic elastomeric copolymers (e.g., poly(ethylene-co-propylene-co-5-ethylidene-2-norbornene).

For example, where a di-functional peroxide is employed, the peroxide can be employed in an amount less than 3×10⁻² moles, in other embodiments less than 2×10⁻² moles, in other embodiments less than 1×10⁻² moles, in other embodiments less than 0.5×10⁻² moles, and in other embodiments less than 0.25×10⁻² moles, of peroxide per 100 parts by weight rubber. Those skilled in the art will be able to readily calculate the number of moles that would be useful for other peroxide based upon this teaching; for example, more peroxide might be useful for monofunctional peroxide compounds, and less peroxide might be useful where peroxides having greater functionality are employed. The amount may also be expressed as a weight per 100 parts by weight rubber. This amount, however, may vary depending on the curative employed. For example, where 2,5-dimethyl-2,5-di(t-butylperoxy)hexane (DBPH) is employed, less than 9 parts, in other embodiments less than 6 parts, in other embodiments less than 3 parts, in other embodiments less than 1.5 parts, in other embodiments less than 0.5 parts, and in other embodiments from about 0.25 to about 1.0 parts by weight peroxide per 100 parts by weight rubber may be employed.

In one or more embodiments, practice of the present invention may advantageously reduce the amount of coagent required to achieve a desired level of cure (e.g., full cure). In one or more embodiments, the amount of coagent employed may be less than 75%, in other embodiments less than 50%, in other embodiments less than 35%, and in other embodiments less than 25% of that amount of coagent required to achieve a desired cure using conventional olefinic elastomeric copolymers (e.g., poly(ethylene-co-propylene-co-S-ethylidene-2-norbornene).

For example, where trimethylol propane trimethacrylate is employed as a coagent, useful amounts include less than 6 parts, in other embodiments less than 2.5 parts, in other embodiments less than 1.0 parts, and in other embodiments from about 0.5 to about 5.0 parts by weight coagent per 100 parts by weight rubber.

Despite the fact that the rubber may be partially or fully cured, the compositions of this invention can be processed and reprocessed by conventional plastic processing techniques such as extrusion, injection molding, blow molding, and compression molding. The rubber within these thermoplastic elastomers can be in the form of finely-divided and well-dispersed particles of vulcanized or cured rubber within a continuous thermoplastic phase or matrix. In other embodiments, a co-continuous morphology or a phase inversion can be achieved. In those embodiments where the cured rubber is in the form of finely-divided and well-dispersed particles within the thermoplastic medium, the rubber particles can have an average diameter that is less than 50 μm, optionally less than 30 μm, optionally less than 10 μm, optionally less than 5 μm, and optionally less than 1 μm. In certain embodiments, at least 50%, optionally at least 60%, and optionally at least 75% of the particles have an average diameter of less than 5 μm, optionally less than 2 μm, and optionally less than 1 μm.

The thermoplastic elastomers of this invention are useful for making a variety of articles such as weather seals, hoses, belts, gaskets, moldings, boots, elastic fibers and like articles. They are particularly useful for making articles by blow molding, extrusion, injection molding, thermo-forming, elasto-welding and compression molding techniques. More specifically, they are useful for making vehicle parts such as weather seals, brake parts such as cups, coupling disks, and diaphragm cups, boots for constant velocity joints and rack and pinion joints, tubing, sealing gaskets, parts of hydraulically or pneumatically operated apparatus, o-rings, pistons, valves, valve seats, valve guides, and other elastomeric polymer based parts or elastomeric polymers combined with other materials such as metal/plastic combination materials. Also contemplated are transmission belts including V-belts, toothed belts with truncated ribs containing fabric faced V's, ground short fiber reinforced V's or molded gum with short fiber flocked V's.

In order to demonstrate the practice of the present invention, the following examples have been prepared and tested. The examples should not, however, be viewed as limiting the scope of the invention. The claims will serve to define the invention.

### EXAMPLES

Samples 1-5

Five thermoplastic vulcanizates were prepared by dynamically vulcanizing various elastomeric copolymers in the presence of a thermoplastic resin by using a peroxide cure system. The characteristics of the various elastomeric copolymers are set forth in Table I.

TABLE I

| | | | | | | | | | Intrinsic | Mooney |
|---|---|---|---|---|---|---|---|---|---|---|
| | | Weight | | | | | | | Viscosity | Viscosity |
| | | % | Weight % | M_{w} | Mₙ | M_{z} | | | (dl/g) @ | (ML₁₊₄) @ |
| | Diene | Diene | Ethylene | (kg/mol) | (kg/mol) | (kg/mol) | M_{w}/Mₙ | <g′> | 135° C. | 125° C. |
| ENB-Rubber | 5-ethylidene-2- | 5.7 | 56 | 380 | 120 | 1886 | 3.1 | — | 2.6 | 91 |
| | norbornene | | | | | | | | | |
| VNB-Rubber I | 5-vinyl-2- | 0.8 | 76 | 400 | 27 | — | 15 | — | — | 23 |
| | norbornene | | | | | | | | | |
| VNB-Rubber II | 5-vinyl-2- | 3 | 63 | 750 | 75 | — | 10 | — | — | 45¹ |
| | norbornene | | | | | | | | | |
| DVB-Rubber I | Divinyl benzene | 0.43 | 69 | 59 | 30 | 98 | 2 | 0.9 | 0.7 | — |
| DVB-Rubber II | Divinyl benzene | 0.9 | 67 | 63 | 35 | 103 | 1.8 | 1.0 | 1.5 | — |
| DVB-Rubber III | Divinyl benzene | 0.45 | 47 | 175 | 58 | 448 | 3.0 | 0.8 | 1.8 | — |

¹Measure with 100 phr oil.

Molecular weight of the copolymers was determined using a Waters 150 C high temperature GPC instrument. Intrinsic viscosity was measured in Decalin at 135° C. Mooney viscosity ((ML₁₊₄)@ 125° C.) was determined according to ASTM-D 1646. The average branching index was determined by using procedures set forth hereinabove.

The ENB-rubber was poly(ethylene-co-propylene-co-ethylidene-2-norbornene) obtained under the tradename VISTALON™ 7500 (ExxonMobil).

VNB-Rubber I was poly(ethylene-co-propylene-co-5-vinyl-2-norbornene) obtained under the tradename VISTALON™ 1709 (ExxonMobil). VNB-Rubber II was poly(ethylene-co-propylene-co-5-vinyl-2-norbornene) and was synthesized in accordance with U.S. Pat. No. 5,656,693, which is incorporated herein by reference. This rubber was extended with 100 phr of oil. It is noted that a combination of VNB Rubber I and VNB Rubber II were employed in an attempt to achieve an average ethylene content comparable to that of the DVB rubber.

DVB-Rubbers I and II were prepared by using homogeneous (solution) (ethylene-bis(indenyl)zirconium dichloride/MAO metallocene catalysts, and DVB-Rubber III was prepared by using a homogeneous dimethylsilyl-bis(indenyl)hafnium dimethyl/dimethylanilinium tetra(pentafluorophenyl) borate metallocene catalysts. All rubbers were prepared via a batch solution process. The polymerizations were each conducted separately in a 2 L batch reactor at a reactor temperature of 50° C. with the stirrer set at 600 rpm. To begin with, the reactor was heated and purged with nitrogen. The catalyst (2 mg of the zirconium catalyst or 7.2 mg of the halfnium catalyst in 1 ml toluene) was activated by adding the co-catalyst (5 ml, 10% MAO in toluene; or a molar equivalent of co-catalyst to catalyst for the hafnium catalyst) in a dry-box atmosphere and charged into a catalyst tube that was attached to the reactor. The divinyl benzene (DVB) solution (Deltech) was purified by passing through an alumina column, and was collected in a sealed-glass container under dry box atmosphere. The hexane solvent (1000 ml) was charged into the reactor. After venting off the reactor pressure, a scavenger, tri-isobutyl aluminum, (0.2 ml, 1 M solution in hexane, Aldrich) was charged into the reactor followed by the injection of the purified DVB solution (Deltech) to the reactor. Then, a specific volume of propylene (50 ml) was charged to the reactor. The reactor was heated to 50° C. and maintained at that temperature. The ethylene was pressurized to set pressure and the inlet was closed. The catalyst was flushed with 200 ml hexane and high pressure N₂ into the reactor. The ethylene inlet was opened keeping the set pressure. The reactor contents were kept at 50° C. and stirring at 600 rpm for 30 minutes, after which it was cooled to 25° C. and vented off. The reactor content was transferred to a glass container, added 0.5 g of stabilizer (Irganox 1076) and was diluted with isopropanol to precipitate the polymer product. The recovered product was washed with hexane then dried by N₂ purge overnight and then weighed.

The thermoplastic vulcanizates were prepared within a Brabender mixer under a nitrogen atmosphere. The ingredients included 100 parts by weight of elastomeric copolymer (this amount referring only to the rubber component even though the stocks were provided with an oil), 60 parts by weight thermoplastic resin, 50 parts by weight paraffinic oil (including any amount provided within the rubber stock), 42 parts by weight clay, 3 parts by weight antioxidant, 6.6 parts by weight free-radical curative, and 6 parts by weight coagent.

Peroxide was 2,5-dimethyl-2,5-di(t-butylperoxy)hexane obtained under the tradename DBPH PAR 100™ (Rhein Chemie); this peroxide was 50% active in paraffinic oil which refers to the fact that the ingredient included 50% by weight of the active peroxide compound and 50% by weight paraffinic oil. The coagent was triallylcyanurate obtained under the tradename PLC(TAC-50BC)™ (Rhein Chemie), which was a powdered liquid concentrate with 50% active agent in an inert mineral carrier. The thermoplastic resin was characterized by an MFR of about 0.7 dg/min and was obtained under the tradename EQUISTAR™ 510S07A. The antioxidant was tetrakis(methylene 3,5-ditert-butyl-4 hydroxy hydrocinnamate)methane obtained under the tradename IRGANOX™ 1010 (Ciba Geigy).

The characteristics of the resulting thermoplastic vulcanizates are set forth in Table II.

TABLE II

| | Sample | | | | |
|---|---|---|---|---|---|
| | 1 | 2 | 3 | 4 | 5 |
| | Comparative/Inventive | | | | |
| | C | C | C | I | I |
| ENB-Rubber | 100 | — | — | — | — |
| VNB-Rubber I | — | 50 | — | — | — |
| VNB-Rubber II (w/100 phr oil) | | 100 | | | |
| DVB-Rubber I | — | — | 100 | — | — |
| DVB-Rubber II | — | — | — | 100 | — |
| DVB-Rubber III | — | — | — | — | 100 |
| Properties | | | | | |
| Hardness (Shore A) | 77 | 84 | 75 | 76 | — |
| Ultimate Tensile Strength (MPa) | 7.74 | 9.10 | 8.09 | 11.29 | 10.61 |
| Ultimate Elongation (%) | 218 | 208 | 220 | 211 | 211 |
| 100% Modulus (MPa) | 5.37 | 6.61 | 5.14 | 6.58 | 6.5 |
| Tension Set @ 23° C. (%) | 14 | 24 | 16 | 13 | 15 |
| Weight Gain(%), 24 h @ 121° C. | 128 | 112 | 137 | 110 | 111 |
| Compression Set @ 100° C. (%) | 40 | 34 | 36 | 26 | 31 |

Shore hardness was determined according to ASTM D-2240. Ultimate tensile strength, ultimate elongation, and 100% modulus were determined according to ASTM D-412 at 23° C. by using an Instron testing machine. Weight gain was determined according to ASTM D-471. Tension set and compression set were determined according to ASTM D-142.

The data in Table II shows that improved or comparable compression set can be obtained when dynamically curing DVB-rubber as compared to conventional ENB-rubber or VNB-rubber. This is true even where minimal diene content is present within the DVB-rubber. This is believed to provide the opportunity to produce fully cured thermoplastic vulcanizates by employing less peroxide curative and/or coagent than has traditionally been used. As a result, the degradation in mechanical properties often observed by the use of peroxide curatives can be reduced thereby providing the opportunity to produce technologically useful thermoplastic vulcanizates having an overall advantageous balance of properties. It is also believed that these thermoplastic vulcanizates will be characterized by better extrusion performance, which may result from less resin degradation from peroxide. Also, with use of less peroxide, less peroxide by-products may result. To this extent, less gummy deposits or die drool die lip build-up will be expected. Also, because a technologically useful cure can be achieved with less diene present, thermoplastic vulcanizates characterized by technologically useful heat stability would be expected.

Various modifications and alterations that do not depart from the scope and spirit of this invention will become apparent to those skilled in the art. This invention is not to be duly limited to the illustrative embodiments set forth herein.

What is claimed is:

1. A composition comprising:
a dynamically-cured rubber, where the rubber includes one or more mer units of divinyl benzene, and where the rubber is dynamically cured with a free-radical curative; and
a thermoplastic resin.

2. The composition of claim 1, where said dynamically-vulcanized rubber is cured to an extent where less than 5% by weight of the rubber is extractable by cyclohexane at 23° C.

3. The composition of claim 1, where said dynamically-vulcanized rubber is cured to an extent where less than 3% by weight of the rubber is extractable by cyclohexane at 23° C.

4. The composition of claim 1, where the rubber includes a terpolymer of ethylene, at least one α-olefin, and divinyl benzene.

5. The composition of claim 4, where the α-olefin is selected from the group consisting of propylene, 1-butene, 1-hexene, 4-methyl-1 pentene, 1-octene, 1-decene, and combinations thereof.

6. The composition of claim 4, where the terpolymer includes from about 0.15 to about 10 weight percent mer units deriving from divinyl benzene.

7. The composition of claim 4, where the terpolymer includes from about 0.25 to about 3 weight percent mer units deriving from divinyl benzene.

8. The composition of claim 4, where the terpolymer includes from about 40 to about 70 weight percent mer units deriving from ethylene.

9. The composition of claim 4, where the terpolymer includes from about 60 to about 66 weight percent mer units deriving from ethylene.

10. The composition of claim 1, where the rubber, prior to dynamic cure, is characterized by a viscosity average branching index <g′>vis of less than 1.

11. The composition of claim 1, where the rubber, prior to dynamic cure, is characterized by a viscosity average branching index <g′>vis of less than 0.8.

12. The composition of claim 1, where the rubber, prior to dynamic cure, is characterized by a gel content of less than 10% by weight.

13. The composition of claim 1, where the rubber, prior to dynamic cure, is characterized by a gel content of less than 8% by weight.

14. The composition of claim 1, where the rubber is synthesized by employing a bridged metallocene catalyst.

15. The composition of claim 1, where the free-radical curative includes an organic peroxide.

16. The composition of claim 10, where the organic peroxide is selected from the group consisting of di-tert-butyl peroxide, dicumyl peroxide, t-butylcumyl peroxide, α,α-bis(tert-butylperoxy) diisopropyl benzene, 2,5-dimethyl-2,5-di(t-butylperoxy)hexane (DBPH), 1,1-di(tert-butylperoxy)-3,3,5-trimethyl cyclohexane, n-butyl-4-4bis(tert-butylperoxy) valerate, benzoyl peroxide, lauroyl peroxide, dilauroyl peroxide, 2,5-dimethyl-2,5-di(tert-butylperoxy) hexyne-3, diaryl peroxides, ketone peroxides, peroxydicarbonates, peroxyesters, dialkyl peroxides, hydroperoxides, peroxyketals and mixtures thereof.

17. The composition of claim 15, where less than 6 parts by weight peroxide per 100 parts by weight rubber is employed to dynamically cure the rubber.

18. The composition of claim 15, where less than 1.5 parts by weight peroxide per 100 parts by weight rubber is employed to dynamically cure the rubber.

19. The composition of claim 1, where the free-radical curative is employed in conjunction with a coagent.

20. The composition of claim 1, where less than 6 parts by weight coagent per 100 parts by weight rubber is employed to dynamically cure the rubber.
